(19) United States
(12) Patent Application Publication
(10) Pub. No.: US 2012/0005944 A1
(43) Pub. Date: Jan. 12, 2012

(54) Frog Fishing Lure and Method of Use

(75) Inventors: Earl Carswell, Margate, FL (US); Harold Jackson Huggins, Margate, FL (US)

(73) Assignee: Tuscaroran Pro-Lures, LLC., Margate, FL (US)

(21) Appl. No.: 12/833,230

(22) Filed: Jul. 9, 2010

(51) Int. Cl. A01K 85/00; A01K 85/01

(52) U.S. Cl. 43/42.3; 43/42.24; 43/42.41

(57) ABSTRACT

A realistic, solid-bodied, plastic frog fishing lure with hind legs and webbed feet for providing vibration for attracting fish, the frog fishing lure capable of correcting itself underwater so that the lure runs in an upright position at all times when being fished.

### FIELD OF THE INVENTION

This invention relates to fishing lures and, in particular to a frog fishing lure and use thereof.

### BACKGROUND OF THE INVENTION

The fishing industry has become a multi-billion dollar business. Manufacturers world-wide are continuously researching and developing new products for introduction into the consumer market. No area of the industry is more saturated with new products than the area of fishing lures. Fishing lures come in various categories, shapes, sizes and colors. There are hard baits, such as crankbaits and stickbaits whose profile and action resemble that of forage fish, such as shad, sunfish and minnows. There are blade baits that can be fished on top of or below the surface of the water that send out vibration and flash into the water to attract gamefish. There are also jigs and spoons. No bait, however, has been more instrumental in catching fish across the globe than the soft plastic baits, such as the plastic worm.

While the plastic worm is still a mainstay in the tackle boxes of fishermen throughout the world, other forms of the soft plastic bait have become increasingly popular. This is no truer than in the bass fishing arena where plastic frog imitations have been and are increasingly becoming more and more popular.

Frog lures have been carved and tied since humans began fishing, and their retail distribution in the United States date back to the early 1900s when one of the first rubber frog lures was offered for sale. A few years later, the company that offered one of the first rubber frog lures developed and sold another version of a frog that was equipped with a spinning metal prop.

In 1905, one of the first ever frog lures was patented to inventor Jay B. Rhodes. This mechanical frog was designed with legs that kicked when the lure was retrieved.

In 1929, Al Foss of Cleveland, Ohio was granted a U.S. patent for his Frog Wiggler. The Frog Wiggler came in two sizes, a ¾ oz. No. 11 and a ½ oz. No. 12. This frog lure was designed to be fished with strips of pork rind attached.

In 1927, Jim Heddon introduced the Luny Frog, which was made of a celluloid material called pyralin. These lures were made in both open-leg and closed-leg models.

In the 1950's, a man named Harry Ehlers was employed at a company that manufactured rubber rain boots. Working in the factory, Ehlers had an idea for an improved plastic frog lure. Ehlers' frog was soft-bodied and hollow, with a weedless hook on the underside and a design that made it tip up when at rest so that the line attachment was less inclined to snag in weeds. The Snag Proof Company continues to make Ehlers' original frog lure along with other models.

In the 1990's Fred Arbogast manufactured a lure called “Fred's Frog.” With its wooden body, glass eyes, and pork rind legs, it incorporated features from a variety of early lures.

Today, dozens of frog lures are available from various fishing tackle manufacturers and are generally classified as “soft-bodied” or “hard-bodied” frogs.

Soft-bodied frogs, such as the Spro® Dean Rojas Bronzeye frog, are usually made from a soft plastic material capable of being compressed or collapsed when a fish strikes at the lure. These “hollow”, soft-bodied frogs are usually equipped with a double-hook design such that when a fish strike at and engulfs the frog lure in its mouth, the soft-bodied lure compresses or collapses thus allowing the fish to become impaled by the hook. These soft-bodied frog lures can also be equipped with legs that kick or skirts that flutter.

Hard-bodied frogs, such as the Stanley® Ribbit Frog, are also made from plastic materials; however, the body of these types of frog lures are solid and generally equipped with legs that act as paddles for creating vibration to attract fish. Unlike, the soft-bodied frogs, the hard-bodied frogs are generally not equipped with a hook, and therefore, the angler must chose what size and shape hook to utilize when fishing the lure.

One of the desired features of the soft-bodied or hard-bodied frog lures is the ability of an angler to fish them weedless allowing for the lure to be thrown into the heaviest cover where fish may be located without getting tangled in the cover and interfering with the action of the lure.

### SUMMARY OF THE INVENTION

While advancements in the frog lure technology have been made, these soft-bodied and hard-bodied frog lures are not without fault. For example, soft-bodied frog lures have a tendency to fill with water, thus increasing the weight of the lure and causing the lure to run subsurface, rendering it less weedless. Soft-bodied and hard-bodied frog lures also have a tendency to not fish true (upside down). For example, when soft-bodied and hard-bodied frog lures are cast, there is no guarantee that these lures will land upright each and every casts. This presents a problem to the fishermen in that the upside down position reduces the probability of catching a fish even if the fish eats the lure because the hook is in the incorrect position for a proper hook set, thus, the lure must be reeled in again and recast in the hopes that the lure will land right side up. This not only increases the chances of missing a strike, but also wastes productive fishing time.

In view of the above-mentioned problems, there still exists a need to provide angler with a frog-type lure that is weedless, provides fish attracting action, and is capable of running true each and every cast.

It is an object of the present invention to provide a realistic looking frog fishing lure that produces frog-like swimming action and sound for attracting largemouth bass and other gamefish.

It is another object of the present invention to eliminate the problem with prior art frog-like fishing lures of running upside down by providing a realistic looking frog fishing lure with the capability of running right side up each time the lure is cast.

It is another object of the present invention to provide a realistic looking frog fishing lure with the capability correcting its position to an upright position if the lure is cast and lands upside down.

It is another object of the present invention to provide a realistic frog fishing lure that resembles the appearance of a real frog, having realistic frog color patterns.

It is yet another object of the present invention to provide a realistic frog fishing lure that simulates the action and movement of an actual frog in the water when retrieved.

### BRIEF DESCRIPTION OF THE DRAWINGS

FIG. 1 shows a top (dorsal) view of the frog fishing lure of the present invention.

FIG. 2 shows a bottom (ventral) view of the frog fishing lure of the present invention.

FIG. 3 shows a front view of the frog fishing lure of the present invention.

FIG. 4 shows a side view of the frog fishing lure of the present invention.

FIG. 5 shows a rear view of the frog fishing lure of the present invention.

FIG. 6 shows a side view of a rigged frog lure of the present invention.

FIG. 7 shows a side view of the frog lure of the present invention with a center line drawn through the center of the body of the frog lure showing the positioning of the hind legs in relation to the center line of the frog lure.

FIG. 8a shows a top (dorsal) view of the frog fishing lure of the present invention depicting the dimensions of the lure and the size ratios of the various parts of the frog lure body.

FIG. 8b shows a side view of the frog fishing lure of the present invention depicting the dimensions of the lure and the size ratios of the various parts of the frog lure body.

FIG. 8c shows a bottom (ventral) view of the frog fishing lure of the present invention depicting the dimensions of the lure and the size ratios of the various parts of the frog lure body.

FIG. 8d shows a back view of a webbed foot of the frog fishing lure of the present invention depicting the dimensions of the webbed foot.

### DETAILED DESCRIPTION

Before explaining the present invention in detail, it is to be understood that the invention is not limited to the particular embodiments and that it can be practiced or carried out in various ways.

In accordance with the above-mentioned objects and others, there is provided a new and improved realistic frog fishing lure and a method of fishing therewith. The frog lure of the present invention has a soft plastic body which includes a head, a trunk and a pair of hind limbs. The body being designed such that the lure runs in an upright position in the water column upon retrieval by a angler utilizing a standard fishing outfit, e.g., rod, reel, line, and hook, thereby, increasing the effectiveness in setting the hook on a fish and landing the fish.

The soft plastic body can be hollow or, in preferred embodiments, substantially solid.

When a fishing hook is properly inserted into the body of the frog lure of the present invention and the frog lure is cast into the water, the lure will land in an upright position and begin to sink. In situations wherein the frog lure lands in an upside down position, the fishing lure immediately begins a corrective move to return to the upright position in the water. If the frog lure of the present invention lands on or is retrieved into an obstruction, e.g., a log, weeds, lilly pads, and is rendered upside down, the frog lure will begin a corrective move to return to the upright position once the lure has been pulled off the obstruction into open water. This upright position is critical to the effectiveness of the lure to catch fish. When a frog-type lure is retrieved in an upside down position and it is eaten or taken by a fish, this upside down position makes it difficult to effectively set the hook which usually enables the fish to swim away unhooked. The hookup ratio is diminished when a frog lure runs upside down.

In certain embodiments there is provided a frog-like fishing lure, comprising a body comprising a head, a trunk, a pair of hind legs and a pair of inwardly pointing webbed feet, wherein the lure is capable of self-correcting its position upon entry into a body of water and allowing the lure to be retrieved in an upright position. The body of the fishing lure comprises a dorsal side, a ventral side and two lateral sides, the dorsal side having an indentation having a length extending through a portion of the body, the ventral side having an oblong, v-shaped groove having a length extending a portion of the body, wherein the indentation and v-shaped groove provide a location for an angler to insert a hook into the body of the lure.

The head of the fishing lure of the present invention may further comprise a nose, a pair of upward protruding eyes positioned behind the nose on the dorsal side of the body and a pair of circular eardrums, each ear drum being positioned on a lateral side behind the eyes. The eyes are preferably three-dimensional eyes.

The trunk of the fishing lure is positioned behind the head of the body and extends distally towards a point of interconnection with the hind legs.

The hind legs may comprise an upper leg and a lower leg, the hind legs being interconnected to the trunk of the body at one end and the webbed feet at an opposite end, the hind legs being positioned above a center line of the lure body, wherein the hind legs provide the self-correcting capability of the lure.

In certain embodiments, the webbed feet have a plurality of toes and webbing and the webbed feet are capable of producing noise on a retrieve that is effective in attracting game fish to the lure.

In certain other embodiments, the dorsal side and lateral sides of the lure have a plurality of bumps or warts resembling the texture of real frog skin.

In certain other embodiments there is provided a frog-like fishing lure, comprising a body comprising a head, a trunk, a pair of hind legs and a pair of inwardly pointing webbed feet, the head, trunk, hind legs and webbed feet; the body having a dorsal side, a ventral side and a lateral side, wherein the dorsal side is flat and has an indentation having a length extending through a portion of the body, and the ventral side being oval shaped extending from the head and trunk to the beginning of the hind legs, the ventral side having an oblong, v-shaped groove having a length extending a portion of the body; the head comprising a nose, a pair of nostrils, a pair of upwardly protruding eyes and a pair of circular eardrums; the hind legs comprising an upper leg and a lower leg, the upper leg being interconnected to the trunk of the body at one end and the lower leg being interconnected to the webbed feet at an opposite end, the hind legs being positioned above a center line of the lure body, wherein the hind legs provide the self-correcting capability of the lure.

In certain embodiments the frog lure of the present invention is a floating lure. In certain other, and preferred embodiments, the frog lure is a sinking lure.

The invention is further described in more detail below.

### DETAILED DESCRIPTION OF THE PREFERRED EMBODIMENTS

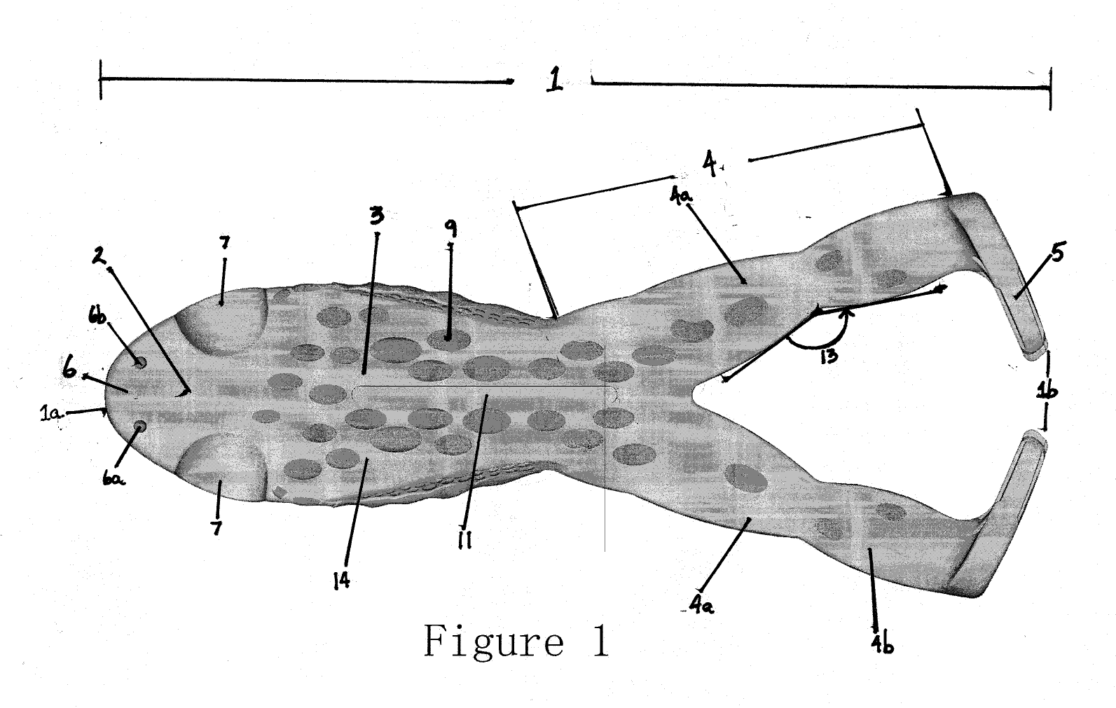

In certain embodiments of the present invention there is provided a soft plastic, one-piece, solid-bodied, frog-like fishing lure, the body 1 of the fishing lure having a head 2, a trunk 3, a pair of hind legs 4, and a pair of webbed feet 5 as shown in FIG. 1. The body 1 of the fishing lure has a proximal end 1a and a distal end 1b also shown in FIG. 1.

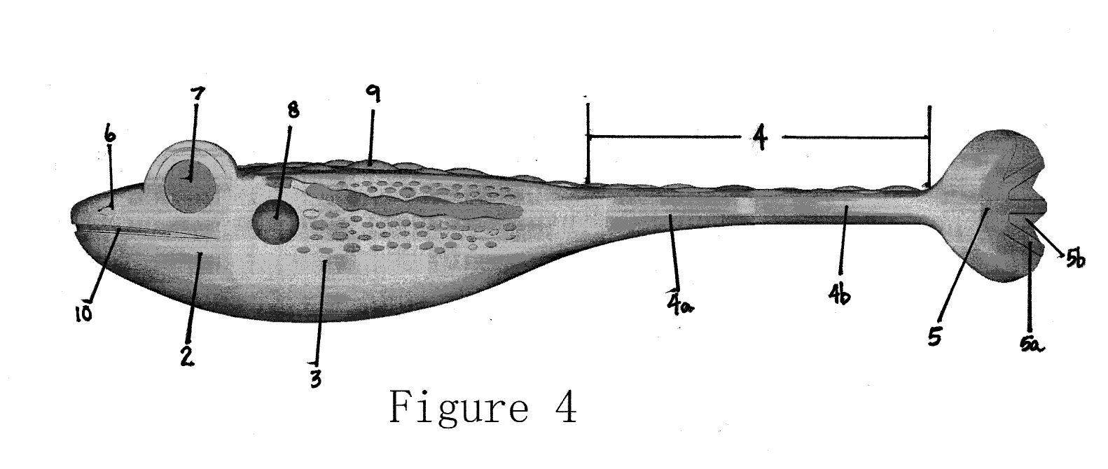

The head 2 portion of the frog lure has a nose 6 containing a pair of nostrils 6a 6b, a pair of eyes 7, and a pair of circular eardrums 8. The eyes 7 are positioned behind the nose 6 on the dorsal (top) side of the frog lure and protrude upwards from the dorsal side to provide a life-like appearance as shown FIG. 1. The circular eardrums 8 are positioned directly behind the eyes 7 on the lateral sides of the frog lure and further provide a life-like frog appearance as shown in FIG. 4.

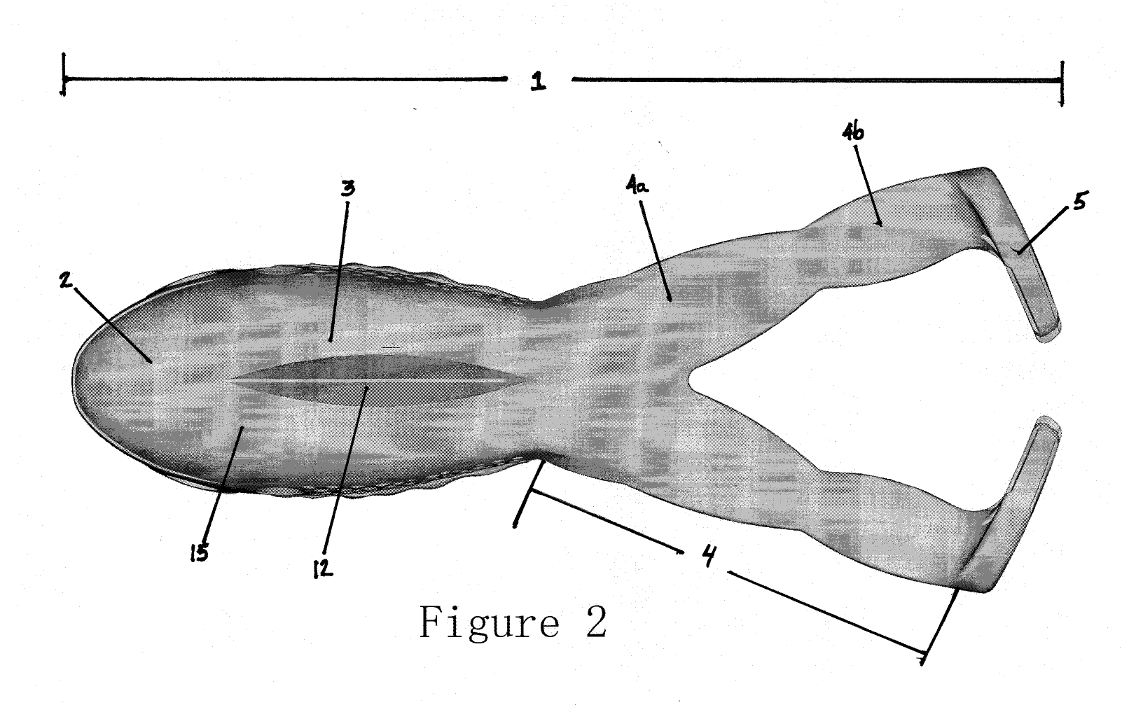

The trunk 3 of the frog lure body 1 is positioned directly behind the circular eardrums 8 of the head 2 and extends distally towards the pair of hind legs 4. Each hind leg 4 comprises an upper leg 4a and a lower leg 4b. The upper legs 4a extend distally towards the lower legs 4b and the lower legs 4b extend distally towards inward pointing webbed feet 5 as shown in FIGS. 1 and 2.

In certain embodiments of the present invention, the upper legs 4a are tapered as they extend distally towards the point of interconnection with lower legs 4b whereas the lower legs 4b gradually widen as they extend to the point of interconnection with the webbed feet 5 as shown in FIGS. 1 and 2. The tapering of the upper legs 4a to the point of interconnection 4c with the lower legs 4b form angle 13 on the inside portion of the hind legs 4 that is important to the function of the hind legs 4 and webbed feet 5 of the lure. For example, it is important that this inside angle be such that when the frog lure is held between an angler's fingers in an upright position at the head 2 section of the bait and the hind legs 4 are allowed to freely droop down, the webbed feet 5 do not touch.

In certain other embodiments of the present invention, instead of upper legs 4a and lower legs 4b, the hind legs 4 of the frog lure comprise a straight-legged section that is slightly curved inward towards the point of interconnection with the inward pointing webbed feet 5 (not shown). The inward curvature of the hind legs 4 is also important to the function of the hind legs 4 and webbed feet 5 of the lure. For example, it is important that this inward curvature be such that when the frog lure is held between an angler's fingers in an upright position at the head 2 section of the bait and the hind legs 4 are allowed to freely droop down, the webbed feet 5 do not touch.

The hind legs 4 of the frog lure of the present invention are preferably flat on both the dorsal and ventral sides, but may contain a plurality of bumps or warts 9 as described in further detail below.

In either of the above-mentioned embodiments of paragraphs [0034] and [0035], while it is important for the webbed feet 5 not to touch for the frog lure to obtain optimal performance, the distance between the webbed feet 5 is not critical, however, the distance may range from about 0.5 mm to about several millimeters. Preferably the distance is about 3 mm.

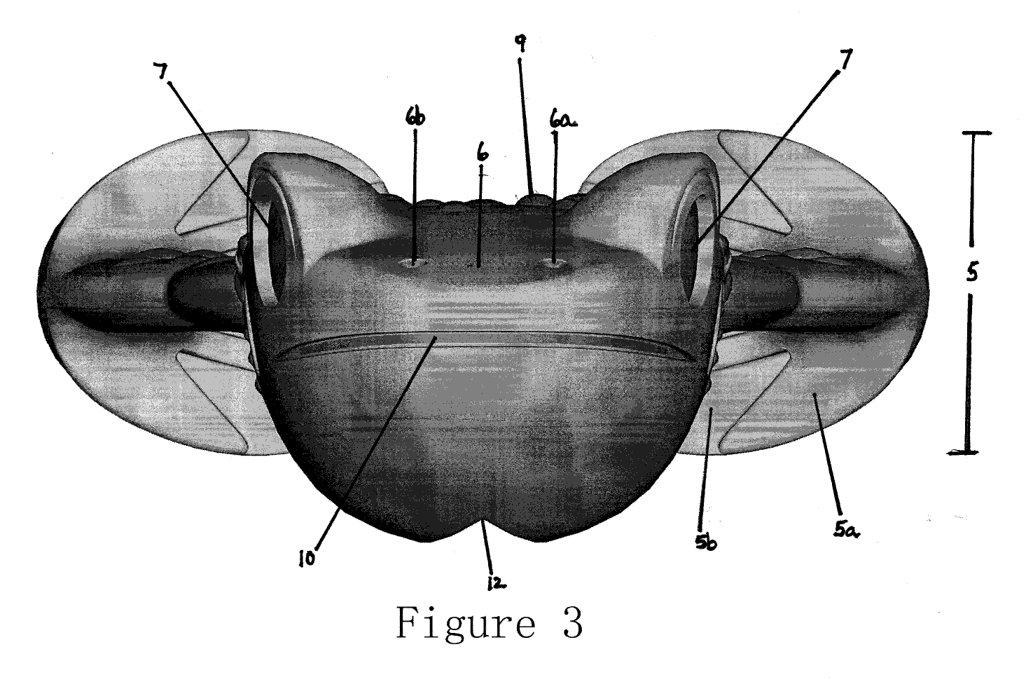

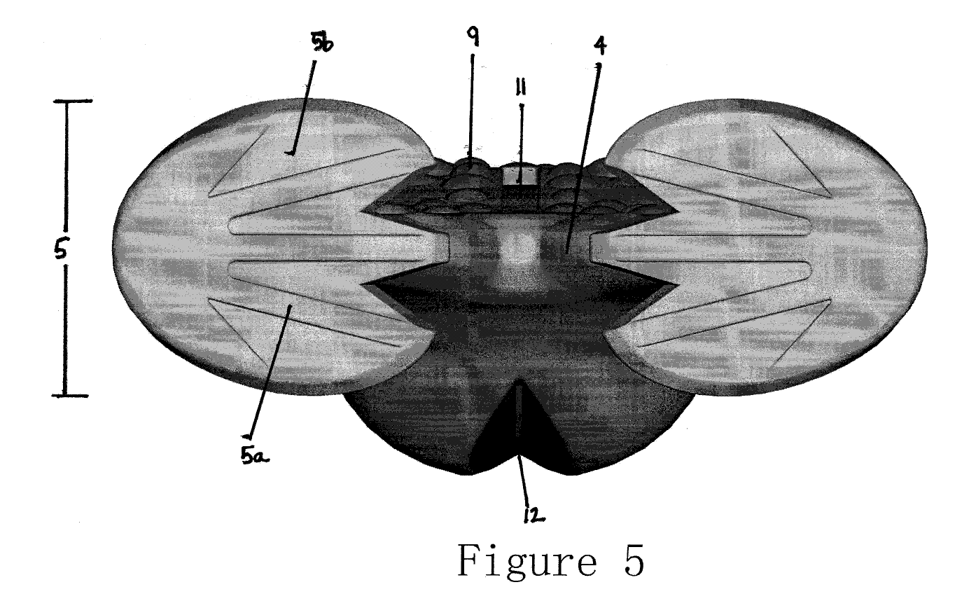

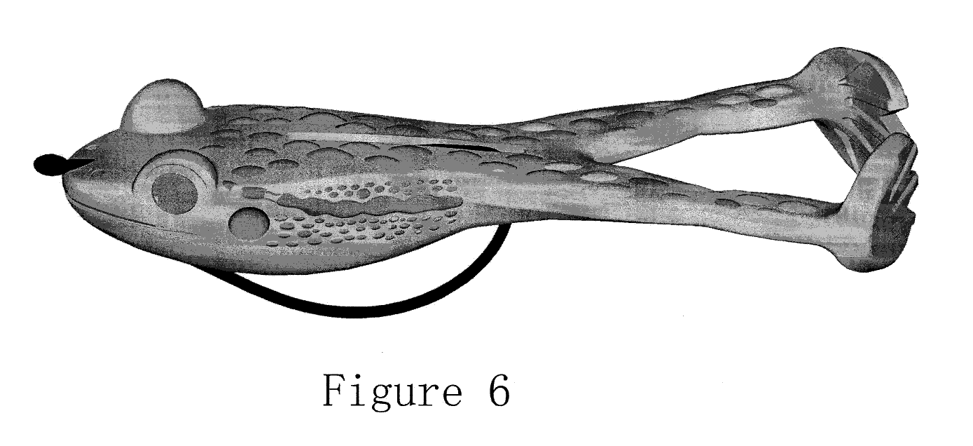

The webbed feet 5 have a plurality of toes 5a and webbing 5b as shown in FIGS. 3-5. The webbed feet 5 simulate a frog's web-like pattern and produce a high level of noise that is effective in attracting largemouth bass and other game fish.

The frog lure body 1 of the present invention has a dorsal side 14 (FIG. 1) and a ventral side 15 (FIG. 2). The dorsal (top) side 14 of the frog lure body 1 is predominantly flat, except for the upward protrusion of the eyes 7. The eyes 7 can be any art known type of eye utilized in the manufacture of fishing lures, preferably the eyes 7 are three-dimensional eyes.

In certain embodiments of the invention, the dorsal (top) side 14 may contain a plurality of bumps or warts 9 that simulate the warts that are generally found on the skin of a real frog as shown in FIG. 1. These bumps or warts 9 may cover the entire dorsal side 14 of the body 1. In certain embodiments, these bumps or warts 9 may cover a portion of the dorsal side of the body 1. For example, in certain preferred embodiments, the bumps or warts 9 extend from behind the eyes 7 distally to the webbed feet 5 as shown in FIG. 1.

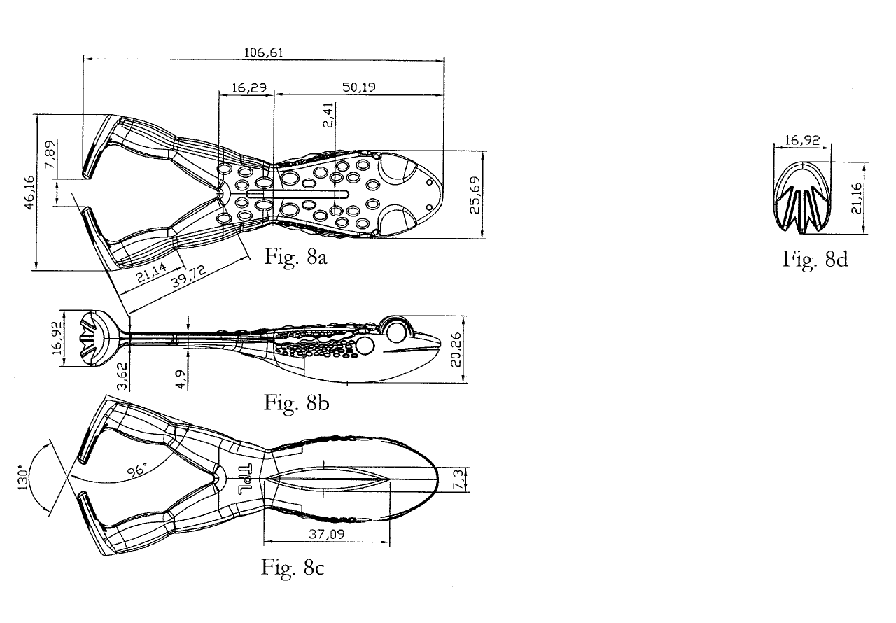

The dorsal side 14 of the frog lure body 1 also has an indentation 11 having a length that extends a portion of the body 1 as shown in FIG. 1. The indentation 11 can be any length, width, or depth so long as when the lure is rigged with a single hook, the point and barb of the hook can be inserted (“skin-hooked”) into the dorsal side 14 of the trunk 3, which provides for a weedless set-up and also increases the ability of the lure to land upright on a cast and/or increases the ability of the lure to correct itself in the water if it lands upside down. In certain embodiments, the length of the indentation 11 ranges from about 15 mm to about 45 mm. In certain preferred embodiments the length of the indentation 11 is about 30 mm. The width of the indentation 11 ranges from about 1 mm to about 5 mm, preferably about 2 mm as shown in FIG. 8.

The ventral (bottom) side 15 of the frog lure body 1 is predominantly smooth as shown in FIG. 2. A portion of the ventral side 15 of the frog lure body 1 extending distally from the nose 6 to about the beginning of the hind legs 4 is oval-shaped and contains an oblong, v-shaped groove 12 having a length that extends a portion of the body 1 as shown in FIGS. 2, 3, and 5. The placement of the v-shaped groove 12 of the ventral side 15 of the frog lure body 1 is such that the v-shaped groove 12 is positioned slightly forward than the indentation 11 located on the dorsal side 14 of the frog lure body 1. The v-shaped groove 12 can be any length, depth and width so long as the specific placements of the indentation 11 and the v-shaped groove 12 form a convenient location for the angler to insert a hook into the lure body 1 thus rendering the frog lure weedless and, more importantly assisting in the ability of the frog lure to run true (dorsal side up). In certain embodiments, the length of the v-shaped groove 12 ranges from about 15 mm to about 45 mm, preferably from about 20 mm to about 40 mm, and most preferably about 37 mm. The width of the v-shaped groove 12 ranges from about 2 mm to about 8 mm, preferably about 7 mm in width at its widest point.

The indentation 11 and v-shaped groove 12 provide what is known in the art as a hook slot(s) that allow the hook to lay within the exterior surface of the fishing lure bodies until a fish attempts to swallow the fishing lure body, thereby helping to prevent the hook from being snagged on underwater plants as the fishing lure is being retrieved.

In addition to the circular ear drums 8, the lateral sides of the frog lure body 1 may also contain various bumps, ridges, or scale-like marks to further simulate the realistic nature of the frog lure of the present invention.

The frog lure body 1 of the present invention may also have a closed mouth 10 located a the proximal end of the lure body 1 to further simulate the realistic nature of the frog lure of the present invention.

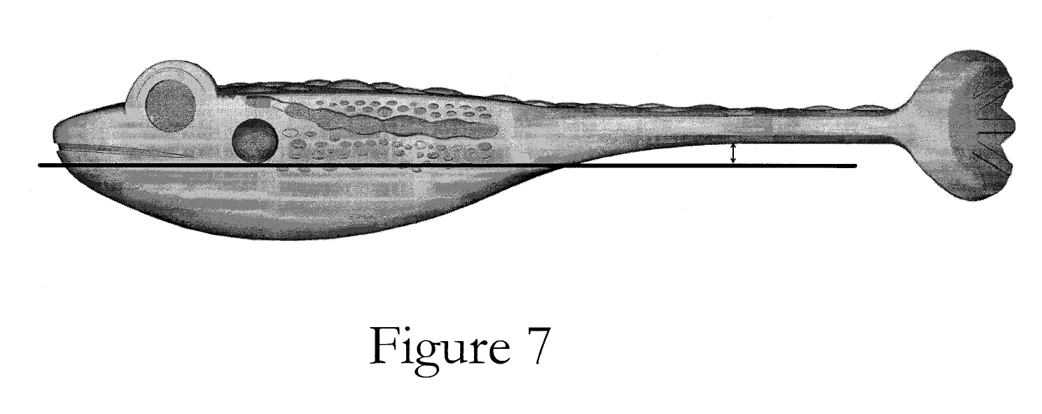

As mentioned above in the “Background of the Invention”, one of the problems associated with prior art known plastic frogs is the tendency of these frogs to land upside down and not have the capability of correcting itself in the water, resulting in the angler having to quickly real in the lure to make another cast in the hopes that the lure will land upright. One of the ways the inventors of the present invention have solved this problem is with the positioning of the hind legs 4 of the present invention. Specifically, unlike prior art known frog lures that have their legs positioned in the middle of or below the center line of the lure body, the hind legs 4 of the frog lure of the present invention are positioned such that the entire portion of the hind legs 4 are above the center line of the frog lure body 1 as shown in FIG. 7. This unique positioning of the hind legs 4 provides the frog lure with the capability of correcting itself to an upright position in the water if the lure lands in an upside down position.

While the positioning of the hind legs 4 of the frog lure is important to the frog lures overall performance, the dimensions of the frog fishing lure also enhances the lures overall performance. The frog lure of the present invention may be any size suitable for fishing. However, the dimensions as shown in FIGS. 8a-8d are preferred.

FIG. 8a shows a top (dorsal) view of the frog fishing lure of the present invention having the following dimensions: the length of the body 1 of the lure being about 106 mm, the length of the body from the tip of the nose 6 to the beginning of the hind legs 4 being about 50 mm, the length of the body 1 from the beginning of the hind legs 4 to the point at where the hind legs 4 separate being about 16 mm, the length of each hind leg 4 from the point at where the hind legs separate to the bottom of the webbed feet 5 being about 39 mm, the length of the lower leg 4b from the point of interconnection with the upper leg 4a to the bottom of the webbed feet 5 being about 21 mm, the width of the body 1 at the location of the circular eardrums 8 being about 25 mm, the width of the indentation 11 being about 2.5 mm, the distance from heel to heel of the webbed feet 5 being about 46 mm, and the distance from toe to toe of the webbed feet 5 being about 8 mm.

FIG. 8b shows a side (lateral) view of the frog lure of the present invention having the following dimensions: the width of the frog body 1 from the ventral side to the top of the eyes 7 being about 20 mm, the width of the hind legs 4 at a point between the upper leg 4a and the point of interconnection of the upper leg 4a and the lower leg 4b being about 5 mm, the width of the lower leg 4b at the point of interconnection with the webbed feet 5 being about 3.5 mm, and the width of the webbed feet 5 being about 17 mm.

FIG. 8c shows a bottom (ventral) view of the frog lure of the present invention having the following dimensions: the length of the oblong, v-shaped groove 12 being about 37 mm, the width of the oblong, v-shaped groove 12 being about 7 mm, the angle formed by the formed by the outside of the hind legs 4 and the bottom of the webbed feet 5 being about 96°, and the outside angle formed by the intersection of straight lines drawn parallel to the bottom of the webbed feet 5 being about 130°.

FIG. 8d shows a rearview of a webbed foot of the frog lure of the present invention having the following dimensions: the length of the webbed foot 5 from the heel to the middle toe being about 21 mm, and the width of the webbed foot 5 being about 17 mm.

While the dimensions shown in FIGS. 8a-8d are preferred, any size frog lure is contemplated so long as the ratio of the dimensions provide the frog lure with the desired action, e.g., ability to land upright and capable of self-correcting itself to an upright position after the lure has been cast into the water. For example, if a frog lure body 50% of the size of the frog lure body shown in FIG. 8a is desired, the ratio of the overall body length to the length of the head and trunk would remain about 2:1. Therefore, if the overall length of the body was, for example about 54 mm, the length of the head and trunk would be about 27 mm.

In addition to the positioning of the hind legs 4 and the dimension of the component parts of the frog lure of the present invention, the weight distribution of the frog lure may also enhance the overall performance of the bait.

The frog fishing lure of the present invention may be rigged with any brand and size hook known in the art to operate properly. For example, the frog fishing lure may be rigged with a wide-gap or offset hook ranging from a size of about 1/0 to about 7/0. Preferably, the frog lure of the present invention is rigged with a size 5/0 extra wide gap hook.

Once rigged, the frog lure of the present invention is cast to a desired location in the water. If the lure does not land upright (dorsal side up) the angler need only pause to allow the lure to immediately begin a corrective move to return to the upright position in the water.

The frog fishing lure of the present invention may be made from numerous materials known to those of skill in the art of the plastics industry such as, but not limited to, polymers, elastomers and rubbers. For example, the frog fishing lure of the present invention may be made from flexible synthetic resins, such as liquid Plastisol available from numerous manufacturers. Preferred materials may include polymers of propylene, ethylene, and various polymer-based resins.

In certain embodiments, the frog fishing lure of the present invention may be made from elastomers such as those described in U.S. Pat. No. 7,266,922, the disclosure of which is hereby incorporated by reference in its entirety.

The hardness of the frog fishing lure of the present invention may vary. The durometer is typically used as a measure of hardness in polymers, elastomers and rubbers. Developed in the 1920s by Albert F. Shore, the durometer scale for hardness utilizes slightly different measurement systems (type A and type D scales). The type A scale is for softer plastics, while the type D scale is for harder ones. The frog fishing lure of the present invention may have a durometer hardness on the Shore A scale from about 1 to about 20.

Whatever the material and hardness utilized, the frog fishing lure of the present invention should be made such that they are generally flexible, pliable, capable of being formed into life-like shapes, e.g., a frog shape.

The frog fishing lure of the present invention may also contain various fish attractants into the materials prior to molding to provide additional fish attracting capabilities.

In addition, flecks of sparkle or glitter can be added to the resin to attract fish.

It is also contemplated that pigments can be added to the materials in at least 100 or more colors. Dyes could be used instead of pigments in liquid plastics. It is also contemplated that other UV stabilizers, fillers and antioxidants can be added to the lure to prevent degradation and reduce costs of manufacture.

The frog lure of the present invention may be made by any art know plastic molding techniques. For example, the frog lure of the present invention may be made utilizing hand pouring or injection molding techniques.

These processes require that a mold be made that is capable of withstanding temperatures of about 350° F. or greater and be capable of holding hot liquid plastic. In one embodiment, the frog lure of the present invention may be manufactured by preheating the mold to the desired temperature and pouring or injecting the hot liquid plastic into the mold. Excess liquid plastic is poured out of the mold and the remaining liquid plastic contained in the mold is allowed to cool. Once cooled the lure body can be removed from the mold and any excess plastic removed.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A frog-like fishing lure, comprising:
a body comprising a head, a trunk, a pair of hind legs and a pair of inwardly pointing webbed feet, wherein the lure is capable of self-correcting its position upon entry into a body of water and allowing the lure to be retrieved in an upright position.

2. The fishing lure of claim 1, wherein the body further comprises a dorsal side, a ventral side and two lateral sides, the dorsal side having an indentation having a length extending through a portion of the body, the ventral side having an oblong, v-shaped groove having a length extending through a portion of the body, wherein the indentation and v-shaped groove provide a location for an angler to insert a hook into the body of the lure.

3. The fishing lure of claim 2, wherein the head further comprises a nose, a pair of upward
protruding eyes positioned behind the nose on the dorsal side of the body and a pair of circular eardrums, each ear drum being positioned on a lateral side behind the eyes.

4. The fishing lure body of claim 3, wherein the eyes are three-dimensional eyes.

5. The fishing lure of claim 1, wherein the trunk is positioned behind the head of the body
and extends distally towards a point of interconnection with the hind legs.

6. The fishing lure of claim 1, wherein the hind legs further comprise an upper leg and a
lower leg, the hind legs being interconnected to the trunk of the body at one end and the webbed feet at an opposite end, the hind legs being positioned above a center line of the lure body, wherein the hind legs provide the self-correcting capability of the lure.

7. The fishing lure of claim 6, wherein the webbed feet have a plurality of toes and webbing.

8. The fishing lure of claim 7, wherein the webbed feet produce noise on a retrieve that is
effective in attracting game fish to the lure.

9. The fishing lure of claim 2, wherein the dorsal side and lateral sides of the lure have a
plurality of bumps or warts resembling the texture of real frog skin.

10. The fishing lure of claim 1, wherein the body is substantially solid.

11. The fishing lure of claim 1, wherein the fishing lure sinks upon entry into the water.

12. A frog-like fishing lure, comprising:
a body comprising a head, a trunk, a pair of hind legs and a pair of inwardly pointing webbed feet, the head, trunk, hind legs and webbed feet;
the body having a dorsal side, a ventral side and a lateral side, wherein the dorsal side is flat and has an indentation having a length extending through a portion of the body, and the ventral being oval shaped extending from the head and trunk to the hind legs, the ventral side having an oblong, v-shaped groove having a length extending a portion of the body;
the head comprising a nose, a pair of nostrils, a pair of upwardly protruding eyes and a pair of circular eardrums;
the hind legs comprising an upper leg and a lower leg, the upper leg being interconnected to the trunk of the body at one end and the lower leg being interconnected to the webbed feet at an opposite end, the hind legs being positioned above a center line of the lure body, wherein the hind legs provide the self-correcting capability of the lure.

13. The fishing lure of claim 12, wherein the eyes are three-dimensional eyes.

14. The fishing lure of claim 12, wherein the webbed feet have a plurality of toes and webbing.

15. The fishing lure of claim 14, wherein the webbed feet produce noise on a retrieve that is effective in attracting game fish to the lure.

16. The fishing lure of claim 12 wherein the dorsal side and lateral sides of the lure have a plurality of bumps or warts resembling the texture of real frog skin.
